(19) United States
(12) Patent Application Publication
(10) Pub. No.: US 2005/0015730 A1
(43) Pub. Date: Jan. 20, 2005

(54) Systems, methods and computer program products for identifying tab order sequence of graphically represented elements

(76) Inventors: Srimanth Gunturi, Morrisville, NC (US); Richard Lee Kulp, Cary, NC (US); Gili Mendel, Cary, NC (US); Rebecca Schaller, Cary, NC (US); Peter Walker, Fuquay-Varina, NC (US); Joe Winchester, Otterbourne (GB)

Correspondence Address: MYERS BIGEL SIBLEY & SAJOVEC, PO BOX 37428, RALEIGH, NC, 27627, US

(21) Appl. No.: 10/619,260

(22) Filed: Jul. 14, 2003

(51) Int. Cl. G09G 5/00

(52) U.S. Cl. 715/777; 715/764

(57) ABSTRACT

Methods, systems and computer program products are provided for displaying a plurality of visual elements associated with a computer program application by defining a sequential tabbing order for the plurality of visual elements and displaying at least one graphical linking element extending between the plurality of visual elements. The graphical linking element represents the sequential tabbing order.

### FIELD OF THE INVENTION

The present invention relates to systems, methods and computer program products, and more particularly, to systems, methods and computer program products used in developing computer program applications.

### BACKGROUND OF THE INVENTION

The proliferation of computers throughout numerous aspects of life has resulted in efforts to make the use of computers more intuitive. These efforts have caused, at least in part, a trend to include graphical user interfaces (GUIs) in computer program applications as well as in computer program application development tools. Many operating systems provide graphical user interfaces. These operating systems all commonly rely on a “window like” work space for applications, operating system information, such as directory information, and program groupings. Multiple windows may be displayed on the screen of a computer display device simultaneously in what is often referred to as a “desktop.” Windows within a desktop are defined by a border which surrounds the window and may also include a title bar and in some cases a series of menu choices which may be implemented in “pull down” menu form and used to manage the appearance and contents of the window. In combination with a pointing device, such as a mouse, windows may be independently moved and resized by “dragging” a border to a new location.

Many computer program applications have been developed using visual tools which take advantage of graphical user interfaces. The applications which are developed using these visual tools include those applications which themselves have user interaction, and therefore often include graphical user interfaces. Oftentimes, these user interfaces are implemented in a windows environment. The applications may be developed for use in network environments, distributed systems environments, or on stand-alone personal computers.

As part of the application development process, the developer must design and implement the user interface for the application. Thus, the developer uses visual tools to not only select the type of individual user interface element or other component to be included in an application (“visual element”) but also the location of the visual element on the user interface, and any other attributes or properties that are to be associated with the particular element. Visual elements may include, for example, field labels, entry fields, and push buttons, which may be labeled.

Visual elements of a graphical user interface generally are displayed to a user of the application, and are enabled for traversal access by a user in a specific order. This order may be referred to as the “tabbing” order. Thus, “tabbing” order may be defined as the sequence in which visual elements of a user interface for an application will receive “focus” when the “tab” key is pressed by the user. The tabbing order of the elements for an application impacts the ability of an end user of the application to use the application, generally, and, more particularly, impacts the end user's ability to quickly navigate among the visual elements versus multi-step movements using a mouse to cause focus or selection change among the visual elements. Generally, by default, the tabbing order is the order in which the elements were placed on the user interface by the developer during creation of the application. Often, an application developer changes the tabbing order from its initial setting.

An application developer faces a number of problems when designing computer program applications, and in particular, when designing the user interfaces for the applications. One problem relates to the expected use of the tabbing order by the applications user and the ability of the developer to view, comprehend and change the tabbing order defined during the development process. The difficulty presented by the first problem to the developer increases as the number of visual elements in the user interface increases. During the development of the user interface for an application, which generally requires designing the visual elements, designing the relationships between the visual elements, and selecting the locations of the visual elements in the user interface, the developer preferably needs to review the visual element designs, relationships and locations in the user interface. This includes being able to review the visual elements and the tabbing order of the visual elements in order to insure the accuracy of the tabbing order.

A number of programming tools exist for assisting in the development of applications, including tools or methods which assist in the reviewing of the tabbing order. Some programming tools assist the developer in defining the tabbing order of visual elements for user interfaces of program applications and also permit the user to view the defined tabbing order. In particular, the programming tool may display the tabbing order defined by the developer in a textual list which specifies the tabbing order. The textual list may be displayed by accessing a “pop-up” menu. The developer may use the textual list of the tabbing order and, in combination with the actual user interface elements displayed to the user, view the defined tabbing order for the elements. This method for displaying the tabbing order to the developer may be referred to as a “static” approach.

Another “static” method for displaying the tabbing order to the developer is by labeling the visual elements on the user interface. The “labeling” method, which is illustrated by an exemplary display screen 10 in FIG. 1, numerically labels the elements on the editing user interface surface (i.e., the “work space”) to identify the tabbing order for the visual elements. In the display screen 10, a plurality of visual elements 20A-20F such as push buttons and data entry fields are provided. The visual elements are labeled with associated text such as “To-Do Item”, “Add”, “Remove”, etc., which will be displayed to the end user of the graphical user interface. Labels or order tags 30A-30F are also provided in the display screen 10 and are each disposed adjacent a respective one of the visual elements 20A-20F. The order tags 30A-30F each include a numerical text (i.e., “1”, “2”, etc.) within a circle indicating the tabbing order for the push buttons and data entry fields.

The visual elements of a user interface also may be grouped. A distinct tabbing order may be defined within each tabbing group. A detailed description of a labeling method of this type is provided in “Grouping Objects for Tabbing and Cursoring in Visual Programming,” by Cox, et al., IBM Technical Disclosure Bulletin, Volume 38, No. 5, May 1995, pages 561-563, the disclosure of which is incorporated herein by reference.

A third methodology for viewing the tabbing order of visual elements of a user interface provides “visually stepping” through the tabbing order using the “tab” key. This method requires the developer to successively press the “tab” key to determine the next visual element in the tabbing order sequence. In order to proceed through the entire tabbing order sequence, the developer must successively press the “tab” key to visually “step” through all of the elements in the tabbing order sequence. This visual “stepping” method may be referred to as a “dynamic” method for viewing the tabbing order of visual elements since the tabbing order is not visually displayed at one instant but rather is viewed “dynamically” by “stepping” through the sequence.

U.S. Pat. No. 6,252,592 to King et al. discloses systems, methods and computer program products for automatic tab scanning.

### SUMMARY OF THE INVENTION

Embodiments of the present invention provide methods, systems and computer program products for displaying a plurality of visual elements associated with a computer program application by defining a sequential tabbing order for the plurality of visual elements and displaying at least one graphical linking element extending between the plurality of visual elements. The graphical linking element represents the sequential tabbing order.

According to method embodiments of the present invention, a method for displaying a plurality of visual elements associated with a computer program application includes defining a sequential tabbing order for the plurality of visual elements and displaying at least one graphical linking element extending between the plurality of visual elements. The at least one graphical linking element represents the sequential tabbing order.

According to embodiments of the present invention, a system for displaying on a display device a plurality of visual elements associated with a computer program application includes means for defining a sequential tabbing order for the plurality of visual elements, and means for displaying at least one graphical linking element extending between the plurality of visual elements. The at least one graphical linking element represents the sequential tabbing order.

According to further embodiments of the present invention, a computer program product for displaying a plurality of visual elements associated with a computer program application includes a computer readable storage medium having computer readable program code embodied in the medium. The computer readable program code includes computer readable program code to define a sequential tabbing order for the plurality of visual elements and computer readable program code to display at least one graphical linking element extending between the plurality of visual elements. The at least one graphical linking element represents the sequential tabbing order.

### BRIEF DESCRIPTION OF THE DRAWINGS

FIG. 1 is a display screen illustrating a labeling method of the prior art for viewing the tabbing order of visual elements of a user interface;

FIG. 2 is a block diagram of data processing systems according to embodiments of the present invention;

FIG. 3 is a more detailed block diagram of data processing systems according to embodiments of the present invention;

FIG. 4 is a display screen illustrating embodiments of the present invention for representing the tabbing order of visual elements of a user interface;

FIG. 5 is a further display screen illustrating embodiments of the present invention for representing the tabbing order of visual elements of a user interface; and

FIG. 6 is a flow chart illustrating operations of a tab mapping system according to embodiments of the present invention.

### DETAILED DESCRIPTION OF THE PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, “tabbing order” (or “tabbing sequence”) means the sequence in which visual elements (i.e., graphically represented elements) of a user interface for an application will receive “focus” when the “tab” key (or an equivalent) is pressed by the user. On a window only one visual element can be the “focus owner,” and the “focus owner” is the element to which keyboard events are sent. When a visual element receives “focus”, it is enabled for access by the user. For example, a “button” visual element under focus may be enabled to execute a corresponding function when the user presses a designated key such as the “Enter” key. By way of further example, a data entry field under focus may be enabled to receive text from the user's keyboard or other input device.

As will be appreciated by those of skill in the art, the present invention may be embodied as methods, data processing systems, or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to an embodiment of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

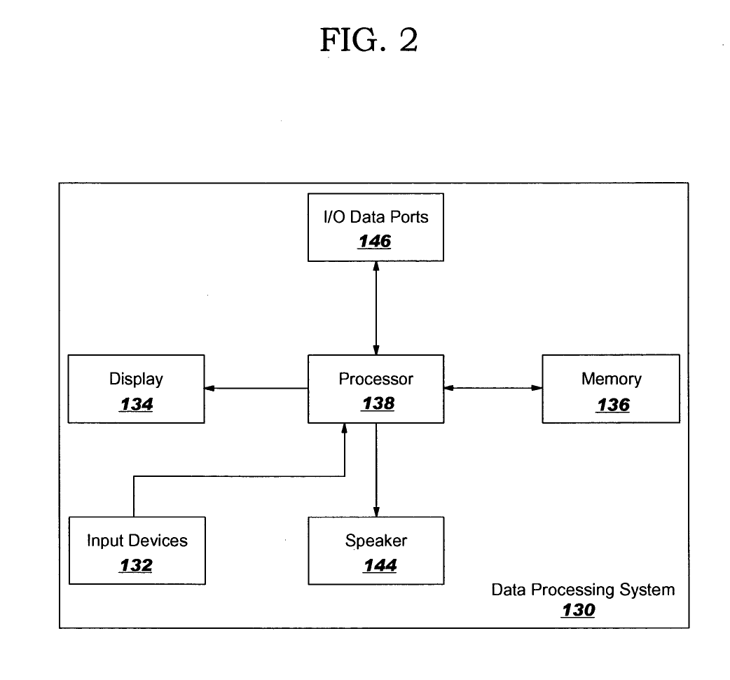

Referring now to FIG. 2, exemplary embodiments of a data processing system 130 in accordance with embodiments of the present invention typically includes input device(s) 132 such as a keyboard or keypad, touch sensitive screen, light sensitive screen, or mouse, a display 134, and a memory 136 that communicate with a processor 138. The data processing system 130 may further include a speaker 144, and an I/O data port(s) 146 that also communicates with the processor 138. The I/O data port 146 can be used to transfer information between the data processing system 130 and another computer system or a network (e.g., the Internet). These components may be conventional components such as those used in many conventional data processing systems which may be configured to operate as described herein.

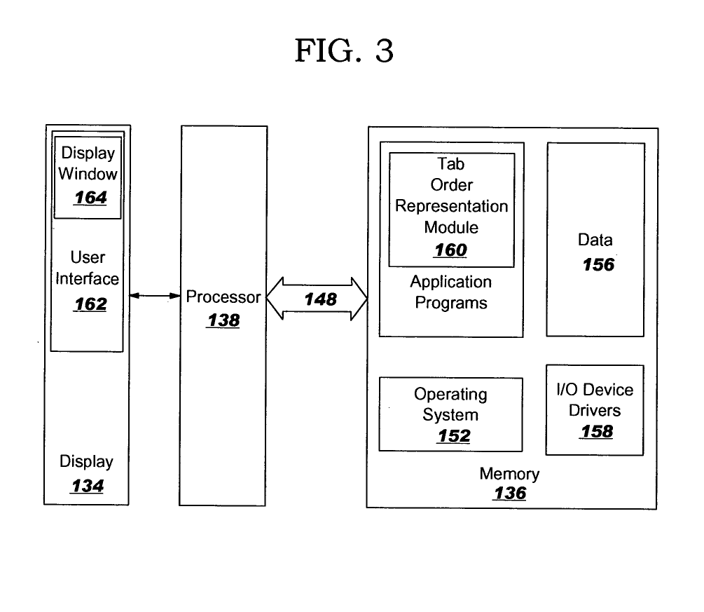

FIG. 3 is a block diagram of embodiments of data processing systems that illustrates systems, methods, and computer program products in accordance with the present invention. The processor 138 communicates with the memory 136 via an address/data bus 148. The processor 138 can be any commercially available or custom microprocessor. The memory 136 is representative of the overall hierarchy of memory devices containing the software and data used to implement the functionality of the data processing system 130. The memory 136 can include, but is not limited to, the following types of devices: cache, ROM, PROM, EPROM, EEPROM, flash memory, SRAM, and DRAM.

As shown in FIG. 3, the memory 136 may include several categories of software and data used in the data processing system 130: the operating system 152; the application programs 154; the input/output (I/O) device drivers 158; and the data 156. As will be appreciated by those of skill in the art, the operating system 152 may be any operating system suitable for use with a data processing system, such as OS/2, AIX or System390 from International Business Machines Corporation, Armonk, N.Y., Windows95, Windows98, Windows2000, or WindowsXP from Microsoft Corporation, Redmond, Wash., Unix or Linux. The I/O device drivers 158 typically include software routines accessed through the operating system 152 by the application program 154 to communicate with devices such as the input devices 132, the display 134, the speaker 144, the I/O data port(s) 146, and certain components of the memory 136. The display 134 includes a user interface 162 that displays data 156 with a display window 164. The application programs 154 are illustrative of the programs that implement the various features of the data processing system 130 and preferably include at least one application which provides the tabbing order mapping aspects of embodiments of the present invention. Finally, the data 156 represents the static and dynamic data used by the application programs 154, the operating system 152, the I/O device drivers 158, and other software programs that may reside in the memory 136. The data 156 can also be displayed in the display window 164.

As further seen in FIG. 3, the application programs 154 include a tabbing order mapping module 160. The tabbing order mapping module 160 carries out operations as described herein for graphically representing a tabbing order of a display screen. Additionally, the tabbing order mapping module 160 may carry out operations as described herein for revising the tabbing order of the display screen. The application programs 154 may include a GUI builder tool including the tabbing order mapping module 160.

While the present invention is illustrated, for example, with reference to a tabbing order mapping module 160, as will be appreciated by those of skill in the art, the tabbing order mapping module 160 may also be incorporated into other components, such as the operating system 152. Thus, the present invention should not be construed as limited to the configuration of FIG. 3 but is intended to encompass any configuration capable of carrying out the operations described herein.

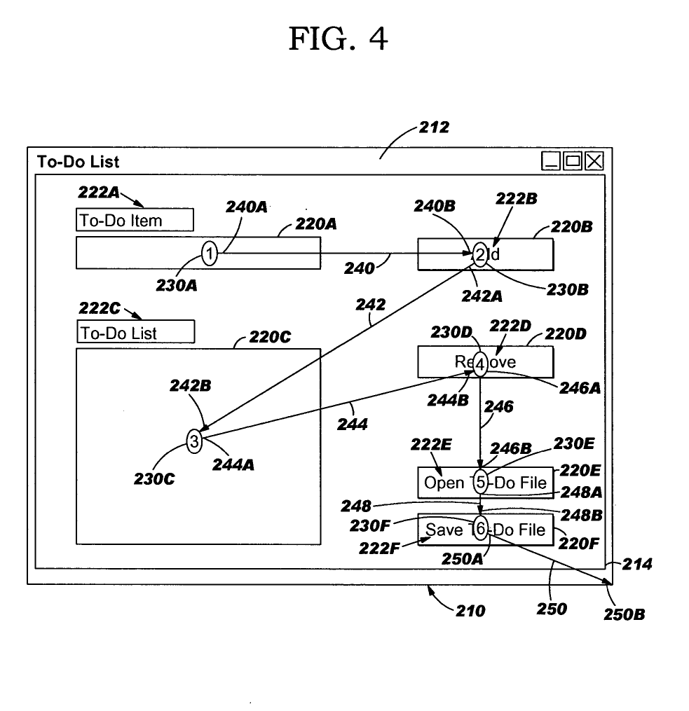

Referring now to FIGS. 4-6, the processing of the tab mapping system and tabbing order mapping module 160 according to the present invention will now be described from the developer's visual perspective.

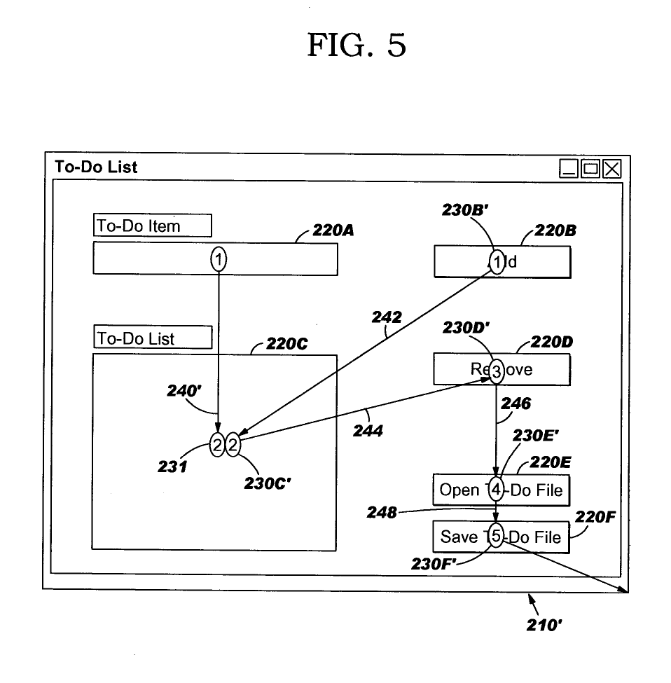

FIGS. 4 and 5 illustrate exemplary display screens 210 and 210′, which are alternatively displayed on the display window 164 and may serve as the work space for editing the user interface. Each of the display screens 210, 210′ includes a plurality of graphically represented controls or visual elements 220A, 220B, 220C, 220D, 220E, 220F (collectively “visual elements 220A-220F”). The display screens 210, 210′ have a traditional format of a “Windows” environment and also include a title bar 212 as well as identification labels 222A, 222B, 222C, 222D, 222E, 222F associated with the visual elements 220A-220F, respectively. The visual elements 220A and 220C are data entry fields and the visual elements 220B, 220D, 220E and 220F are “buttons”. The visual elements illustrated and described above are merely exemplary and those of ordinary skill in the art will appreciate that more or fewer visual elements and/or visual elements of other types may be provided. Likewise, the tabbing orders described below are merely exemplary.

Typically, the visual elements 220A-220F will have been laid out by the developer. The initial defined tabbing order may be the order in which the visual elements 220A-220F were created or placed, with the final tab in the order causing the display to return focus to the first visual element in the tabbing order. The tab mapping system of the present invention may provide means for the developer to visually assess and, optionally, revise the tabbing order that will be experienced by the end user in the user interface when the application under development is deployed.

In the display screen 210 of FIG. 4, the tabbing order is (in sequential order): visual element 220A; visual element 220B; visual element 220C; visual element 220D; visual element 220E; visual element 220F; return to visual element 220A. The tabbing order mapping module 160 and the data processing system 130 generate tabbing order graphical linking elements (in the illustrated embodiments, arrows) 240, 242, 244, 246, 248, each extending between a respective pair of the visual elements 220A-220F. The tabbing order mapping module 160 also generates a tabbing order graphical linking element (in the illustrated embodiments, an arrow) 250 between the visual element 220F and an exit corner 214 of the display screen 210. More particularly, each arrow 240, 242, 244, 246, 248, 250 (collectively “arrows 240-250”) has a respective source end 240A, 242A, 244A, 246A, 248A, 250A and a respective target end 240B, 242B, 244B, 246B, 248B, 250B. To clearly distinguish the source and target ends, the target ends are each provided with arrowheads. The source end of each arrow is located on one visual element 220A-220F (which may be referred to as the “source” control or visual element), while the target end of the arrow is located on another of the visual elements 220A-220F (which may be referred to as the “target” control or visual element) or the exit corner 214. In this manner, the arrows 240-250 graphically represent the tabbing order. The presence of the target end 250B at the exit corner 214 indicates that, when focused on the visual element 220F, pressing “tab” will return focus to the visual element 220A.

To further assist in indicating the tabbing order, textual order tags 230A, 230B, 230C, 230D, 230E, 230F (collectively “order tags 230A-230F”) are each provided on a respective one of the visual elements 220A-220F. The textual order tags bear suitable numerical text (i.e., “1”, “2”, “3”, etc.) indicating the relative rank of each associated visual element 220A-220F in the tabbing order.

Thus, in accordance with the present invention, the developer is provided with a clear and informative graphical representation or map indicating the tabbing order or sequence of the visual elements in the display screen 210. The numbered arrows 240-250 between the controls or visual elements visually indicate the direction and flow of the tab key between visual elements. This graphical representation may allow the developer to more quickly and confidently view, assess and comprehend the tabbing order relationship between selected ones of the visual elements 220A-220F as well as the overall tabbing order or path of the display screen 210. The arrows 240-250 clearly and intuitively show each relationship. The textual order tags 230A-230F may further assist the developer in assessing and evaluating the tabbing order. However, it will be appreciated from the description herein that the textual order tags 230A-230F can be omitted.

The developer may revise the tabbing order in any suitable manner including, for example, using methods in accordance with the prior art. As discussed below, when the tabbing order is changed, the configuration of the arrows 240-250 may be correspondingly changed to accurately reflect the new tabbing order. If new visual elements are added or visual elements are removed, the tab mapping system may likewise revise the configuration of the arrows to reflect the new tabbing order.

In accordance with some preferred embodiments, the tab mapping system and method are adapted such that the developer can revise the tabbing order by manipulation of the arrows. The developer can modify a tabbing order by dragging and releasing (e.g., using a mouse) an end of a selected arrow from an existing location adjacent a first visual element to a location adjacent a second visual element. The end moved may be either the source end of the arrow or the target end of the arrow. The tab mapping system will automatically modify the tabbing order to reflect the new arrangement of the arrows. If the source end of an arrow is moved to a new visual element, the new visual element will then immediately precede the visual element at the target end of the arrow in the tabbing sequence. If the target end of the arrow is moved to a new visual element, the new visual element will then immediately follow the visual element at the source end of the arrow in the tabbing sequence.

Methods for revising tabbing order as discussed above are illustrated by the exemplary display screen 210′ shown in FIG. 5, referred to in conjunction with FIG. 4. In the illustrative example, the operating system GUI (e.g., Java Swing) allows for multiple roots. The developer has initially created or been provided with the display screen 210 of FIG. 4 with a tabbing order as represented by the arrows 240-250. The developer then drags the target end 240B of the arrow 240 from the visual element 220B to the visual element 220C and releases the target end 240B on the visual element 220C.

The arrow 240 is thereby converted to a new arrow 240′ having a source end 240A′ adjacent the visual element 220A and a target end 240B′ adjacent the visual element 220C. The tabbing order is automatically modified by the data processing system 130 to provide two alternative tabbing sequences. The first tabbing sequence originates with the visual element 220A, and then progresses sequentially to the visual elements 220C, 220D, 220E and 220F. The second tabbing sequence originates with the visual element 220B and likewise progresses sequentially to the visual elements 220C, 220D, 220E and 220F. Thus, each of the first and second tabbing sequences includes a visual element not in the other (i.e., visual element 220A and visual element 220B, respectively). The visual elements 220A and 220B may alternatively receive focus through use of the mouse or an accelerator key, for example. The tab mapping system automatically updates the order tags 230A-230F by replacing them with new order tags 230A′, 230B′, 230C′, 230D′, 230E′, 230F′, respectively, each including text (i.e., “1”, “2”, “3”, etc.) corresponding to their rank in the associated tabbing sequence. Additionally, the tab order mapping system inserts a further order tag 231 indicating the rank of the visual element 220C in the first tabbing sequence.

While the display screen 210′ includes a tab sequence having multiple roots, some windowing systems do not allow multiple roots (i.e., only one visual element can have any given rank or number). In this case, the tabbing order is cyclical and takes in every visual element once and only once before repeating.

According to some preferred embodiments, when the lead end of an arrow is repositioned by the developer, the tab order is automatically revised to accommodate the repositioning. More particularly, the original target of the arrow and the new target of the arrow may swap places in the tabbing order, so that the new target becomes the tab number of the old target and the old target is placed in a default tab order. For example, when the lead end 240B of arrow 240 of display screen 210 (FIG. 4) is dragged and released on visual element 220C, the tab mapping system will update the tabbing order as follows: visual element 220A will remain first in the tabbing order; visual element 220C will become second in the tabbing order; and visual element 220B will become third in the tabbing order. The tab mapping system will redraw line 240 to extend from element 220A to element 220C (with the arrowhead 240B on element 220C), will redraw line 242 such that the arrow 242B is on the end adjacent the element 220B, and will redraw the arrow 244 to extend from the element 220B to the element 220D (with the arrowhead 244B remaining on the element 220D). The tab mapping system will also update the order tags so that the visual elements 220A, 220B, and 220C are labeled with order tag numbers “1”, “3” and “2”, respectively.

According to some embodiments, the response of the tab mapping system to relocation of an arrow is dependent on whether the platform allows multiple roots. If the platform does allow multiple roots, the tab mapping system will, where appropriate, update the tabbing order, arrows and order tags as described with reference to the screen display 210′ to provide multiple tabbing sequences. If the platform or operating system only allows for a single tabbing order, the tab mapping system will update the tabbing order, arrows and order tags as described just above.

As will be appreciated from the foregoing description and illustration, the tabbing order mapping system may allow for efficient and intuitive modification to a tabbing sequence. The arrows 240-250 and 240′ allow for quick and accurate assessment of the tabbing order or tabbing orders even where multiple tabbing sequences are present on the same user interface display screen. Each of the multiple tabbing sequences may or may not join another of the tabbing sequences or may be self-contained. Different tabbing orders could be represented in different colors.

While the arrows 240-250 and 240′ as shown in the display screens 210, 210′ each include a line segment with an arrowhead on the target end thereof, other graphical linking elements may be provided to represent the tabbing order relationships between the visual elements. Preferably, the graphical linking elements are configured and adapted to both graphically connect the two associated visual elements and to indicate the direction of the tabbing sequence as between the two visual elements (i.e., the hierarchy between the visual elements). According to some embodiments, arrows are utilized because they are readily and intuitively understood to indicate a direction and linkage. However, graphical representations of any suitable configuration indicative of polarity (i.e., corresponding to a start or upstream end and a target or downstream end) may be used in addition to or in place of the arrows as shown in the display screens 210, 210′. For example, the arrowhead may be replaced with a differently shaped graphical element and/or the arrowhead or other graphical element may be relocated along the line segment. The line segment may be shaped so as to indicate a direction (e.g., the width of the line segment may be tapered from the start end to the target end or vice-versa).

According to other embodiments, the graphical linking element may be non-directional. In this case, the order tags 230A-230F may be provided to indicate the direction of the tabbing sequence.

According to some embodiments, the arrows (or other graphical link elements) fully connect the two associated visual elements (i.e., portions of the graphical link element contact or overlap each of the two visual elements). However, the graphical linking element may be positioned and configured such that it is somewhat spaced from either or both of the visual elements, so long as the graphical element clearly and graphically indicates the linkage. For example, ends of the arrow may terminate near but not on the two associated visual elements. Likewise, where order tags are employed, the arrows may terminate at a distance from the corresponding order tags.

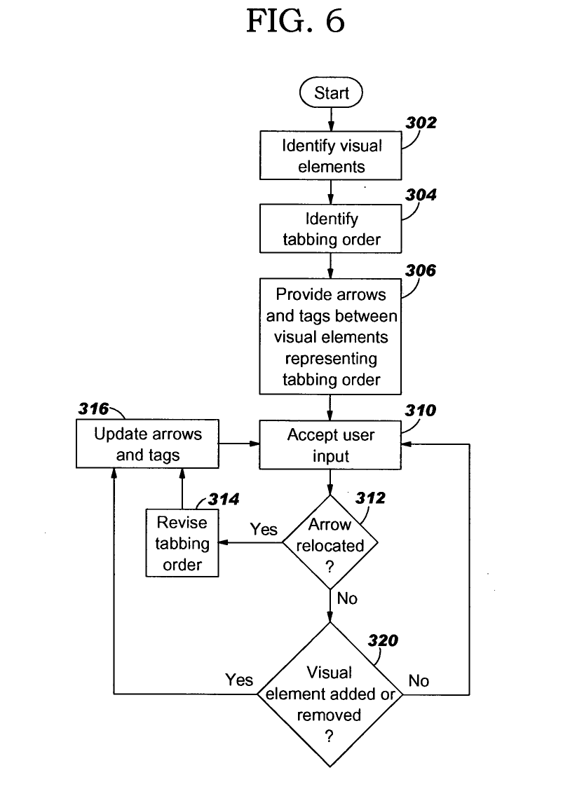

FIG. 6 is a flow chart illustrating the methods, systems, and program products according to certain embodiments of the present invention. It will be understood that each step of the flow chart, and combinations of the steps in the flow chart diagram, can be implemented by computer program instructions. These computer program instructions may be loaded onto a computer or other programmable data processing apparatus to produce a machine such that the instructions which execute on the computer or other programmable apparatus create means for implementing the functions specified in the flow chart step(s). These computer program instructions may also be stored in a computer readable memory that can direct a computer or other programmable apparatus to function in a particular manner, such that the instructions stored in the computer readable memory produce an article of manufacture including instruction means which implement the functions specified in the flow chart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart step(s).

Accordingly, steps of the flow chart illustrations support combinations of means for performing the specified functions, combinations of steps for performing the specified functions and program instruction means for performing the specified function. It will also be understood that each step of the flow chart illustrations, and combinations of steps in the flow chart illustrations, can be implemented by special purpose hardware based computer systems which perform the specified functions or steps, or combinations of special purpose hardware and computer instructions.

Referring now to FIG. 6, a flow chart illustrating the operations of the present invention for mapping the tabbing sequence of the visual elements of a program application will now be described. Processing begins with the identification of the visual components or elements of the tabbing order to be mapped or linked (Block 302). The tabbing order or sequence as between the identified visual elements is then identified or determined (Block 304).

The data processing system then draws or inserts arrows (e.g., the arrows 240A-240F) or other suitable graphical linking elements between the visual elements (Block 306). The data processing system may also draw or insert order tags (e.g., the order tags 230A-230F) on or at each visual element. The arrows and tags are inserted such that they indicate and correspond to the tabbing order determined in Block 304, as discussed in more detail above.

The data processing system then accepts user input (Block 310). If the user input includes moving an end of one of the arrows to a different visual element (e.g., by dragging as discussed above) (Block 312), the data processing system revises the tabbing order (Block 314). Additionally, the data processing system updates the arrows and order tags as needed to reflect the modification to the tabbing order (Block 316). For example, the arrow moved by the user is drawn into the location where the user has deposited the arrow and the text numbers of the order tags are revised as needed to indicate their corresponding numerical ranks in the tabbing sequence(s). Where appropriate, additional order tags such as the order tag 231 (FIG. 5) may be added.

If the user input includes the addition or removal of a visual element (Block 320), the data processing system updates the arrows and order tags to reflect the addition/removal of the visual element and any resulting change in the tabbing order (Block 316).

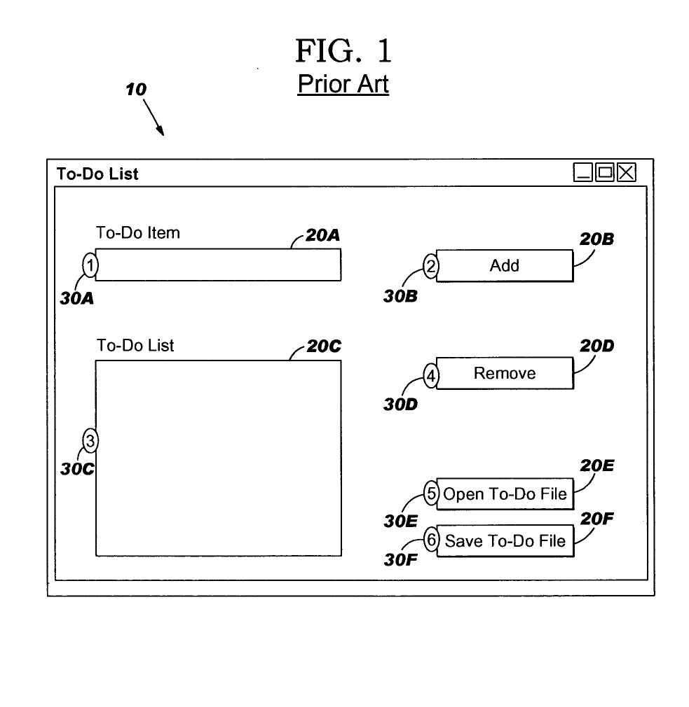

The flowcharts and block diagrams of FIGS. 1, 2, 3 and 6 illustrate the architecture, functionality, and operation of possible implementations of systems, methods and computer program products according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

1. A method for displaying a plurality of visual elements associated with a computer program application, said method comprising:
defining a sequential tabbing order for the plurality of visual elements; and
displaying at least one graphical linking element extending between the plurality of visual elements, wherein the at least one graphical linking element represents the sequential tabbing order.

2. The method of claim 1 wherein displaying at least one graphical linking element includes:
displaying a first graphical linking element extending between a first visual element in the sequential tabbing order and a second visual element in the sequential tabbing order; and
displaying a second graphical linking element extending between the second visual element and a third visual element in the sequential tabbing order.

3. The method of claim 1 wherein the at least one graphical linking element comprises:
a line segment that extends between and graphically connects a first visual element in the sequential tabbing order and a second visual element in the sequential tabbing order; and
a graphical element that indicates the direction of the sequential tabbing order between the first and second visual elements.

4. The method of claim 1 further comprising displaying a plurality of textual order tags such that each of the textual order tags is located adjacent a respective one of the plurality of visual elements and includes text indicating a relative rank of the respective one of the plurality of visual elements in the sequential tabbing order.

5. The method of claim 1 further comprising reconfiguring the at least one graphical linking element to reflect a new sequential tabbing order responsive to a modification of the sequential tabbing order.

6. The method of claim 5 further comprising modifying the sequential tabbing order responsive to user input relocating the at least one graphical linking element relative to at least one of the plurality of visual elements.

7. The method of claim 1 further comprising:
defining a second sequential tabbing order for the plurality of visual elements, wherein the first sequential tabbing order includes a first visual element not in the second sequential tabbing order, and the second sequential tabbing order includes a second visual element not in the first sequential tabbing order;
displaying a first graphical linking element extending between the first visual element and another of the plurality of visual elements, wherein the first graphical linking element represents at least a portion of the first sequential tabbing order; and
displaying a second graphical linking element extending between the second visual element and another of the plurality of visual elements, wherein the second graphical linking element represents at least a portion of the second sequential tabbing order.

8. A system for displaying on a display device a plurality of visual elements associated with a computer program application, said system comprising:
means for defining a sequential tabbing order for the plurality of visual elements; and
means for displaying at least one graphical linking element extending between the plurality of visual elements, wherein the at least one graphical linking element represents the sequential tabbing order.

9. The system of claim 8 wherein the means for displaying at least one graphical linking element includes:
means for displaying a first graphical linking element extending between a first visual element in the sequential tabbing order and a second visual element in the sequential tabbing order; and
means for displaying a second graphical linking element extending between the second visual element and a third visual element in the sequential tabbing order.

10. The system of claim 8 wherein the at least one graphical linking element comprises:
a line segment that extends between and graphically connects a first visual element in the sequential tabbing order and a second visual element in the sequential tabbing order; and
a graphical element that indicates the direction of the sequential tabbing order between the first and second visual elements.

11. The system of claim 8 further comprising means for displaying a plurality of textual order tags such that each of the textual order tags is located adjacent a respective one of the plurality of visual elements and includes text indicating a relative rank of the respective one of the plurality of visual elements in the sequential tabbing order.

12. The system of claim 8 further comprising means for reconfiguring the at least one graphical linking element to reflect a new sequential tabbing order responsive to a modification of the sequential tabbing order.

13. The system of claim 12 further comprising means for modifying the sequential tabbing order responsive to user input relocating the at least one graphical linking element relative to at least one of the plurality of visual elements.

14. The system of claim 8 further comprising:
means for defining a second sequential tabbing order for the plurality of visual elements, wherein the first sequential tabbing order includes a first visual element not in the second sequential tabbing order, and the second sequential tabbing order includes a second visual element not in the first sequential tabbing order;
means for displaying a first graphical linking element extending between the first visual element and another of the plurality of visual elements, wherein the first graphical linking element represents at least a portion of the first sequential tabbing order; and
means for displaying a second graphical linking element extending between the second visual element and another of the plurality of visual elements, wherein the second graphical linking element represents at least a portion of the second sequential tabbing order.

15. A computer program product for displaying a plurality of visual elements associated with a computer program application, said computer program product comprising:
a computer readable storage medium having computer readable program code embodied in the medium, the computer readable program code comprising:
computer readable program code configured to define a sequential tabbing order for the plurality of visual elements; and
computer readable program code configured to display at least one graphical linking element extending between the plurality of visual elements, wherein the at least one graphical linking element represents the sequential tabbing order.

16. The computer program product of claim 15 wherein the computer readable program code configured to display at least one graphical linking element includes:
computer readable program code configured to display a first graphical linking element extending between a first visual element in the sequential tabbing order and a second visual element in the sequential tabbing order; and
computer readable program code configured to display a second graphical linking element extending between the second visual element and a third visual element in the sequential tabbing order.

17. The computer program product of claim 15 wherein the at least one graphical linking element comprises:
a line segment that extends between and graphically connects a first visual element in the sequential tabbing order and a second visual element in the sequential tabbing order; and
a graphical element that indicates the direction of the sequential tabbing order between the first and second visual elements.

18. The computer program product of claim 15 further comprising computer readable program code configured to display a plurality of textual order tags such that each of the textual order tags is located adjacent a respective one of the plurality of visual elements and includes text indicating a relative rank of the respective one of the plurality of visual elements in the sequential tabbing order.

19. The computer program product of claim 15 further comprising computer readable program code configured to reconfigure the at least one graphical linking element to reflect a new sequential tabbing order responsive to a modification of the sequential tabbing order.

20. The computer program product of claim 19 further comprising computer readable program code configured to modify the sequential tabbing order responsive to user input relocating the at least one graphical linking element relative to at least one of the plurality of visual elements.

21. The computer program product of claim 15 further comprising:
computer readable program code configured to define a second sequential tabbing order for the plurality of visual elements, wherein the first sequential tabbing order includes a first visual element not in the second sequential tabbing order, and the second sequential tabbing order includes a second visual element not in the first sequential tabbing order;
computer readable program code configured to display a first graphical linking element extending between the first visual element and another of the plurality of visual elements, wherein the first graphical linking element represents at least a portion of the first sequential tabbing order; and
computer readable program code configured to display a second graphical linking element extending between the second visual element and another of the plurality of visual elements, wherein the second graphical linking element represents at least a portion of the second sequential tabbing order.
